(19) United States
(12) Patent Application Publication
(10) Pub. No.: US 2019/0228363 A1
(43) Pub. Date: Jul. 25, 2019

(54) SYSTEMS AND METHODS FOR MONITORING AND MITIGATING JOB-RELATED STRESS FOR AGENTS USING A COMPUTER SYSTEM IN A CUSTOMER SERVICE COMPUTER NETWORK

(71) Applicant: salesforce.com, inc., San Francisco, CA (US)

(72) Inventors: Adarsha Badarinath, Foster City, CA (US); Roojuta Lalani, Fremont, CA (US); Mannu Mulchandani, San Francisco, CA (US); Nileshkumar Patel, San Rafael, CA (US); Kristen Muramoto, San Francisco, CA (US)

(73) Assignee: salesforce.com, inc., San Francisco, CA (US)

(21) Appl. No.: 15/876,554

(22) Filed: Jan. 22, 2018

(51) Int. Cl. G06Q 10/06; G06Q 30/00

(52) U.S. Cl. CPC G06Q 10/06393; G06Q 30/016; G06Q 10/06398

(57) ABSTRACT

A method for monitoring and mitigating job-related stress for a CSR using a console computer system in a customer service computer network is provided. The method obtains a set of stress metrics comprising at least a quantity of cases assigned to the CSR, a quantity of escalated cases assigned to the CSR, and a quantity of case milestone violations associated with the CSR; computes a stress score for the CSR based on the set of stress metrics from the CRM software platform, the stress score indicating a level of job-related stress for the CSR; transmits the stress score for the CSR for storage and use; and when the stress score indicates a high level of job-related stress for the CSR, the method causes stress mitigation functions to be performed, the stress mitigation functions being associated with case assignments, case routing, and mindfulness module data.

### TECHNICAL FIELD

Embodiments of the subject matter described herein relate generally to the identification and mitigation of job-related stress in a customer service computer network. More particularly, embodiments of the subject matter relate to computing stress scores, generating stress reports, and providing integrated mindfulness tasks via the customer service computer network.

### BACKGROUND

Customer service representatives (CSRs) often work in large customer service centers where the CSRs receive phone calls, computer-based text messages, and other communications from customers, and where the CSRs address, and attempt to resolve, issues raised by customers via the customer communications. Generally, the CSRs complete a variety of tasks based on received customer requests. One particular CSR may experience a heavy workload based on an increased number of customer communications received on a particular day, while experiencing a lighter workload based on fewer received customer communications. A heavy workload can cause an increased stress level for a CSR, which may be exacerbated by confinement to an office or workstation for a period of time equivalent to a standard workday (e.g., eight or nine hours).

Accordingly, it is desirable to monitor and mitigate job-related stress for CSRs working in a customer service center. Furthermore, other desirable features and characteristics will become apparent from the subsequent detailed description and the appended claims, taken in conjunction with the accompanying drawings and the foregoing technical field and background.

### BRIEF SUMMARY

Some embodiments of the present disclosure provide a method for monitoring and mitigating job-related stress for a customer service representative (CSR) using a console computer system in a customer service computer network. The method obtains a set of stress metrics associated with the CSR, from a remote server configured to store a Customer Relationship Management (CRM) software platform, via a communication device communicatively coupled to a processor of the customer service computer network, the set of stress metrics comprising at least a quantity of cases assigned to the CSR, a second quantity of escalated cases assigned to the CSR, and a third quantity of case milestone violations associated with the CSR; computes a stress score for the CSR based on the set of stress metrics from the CRM software platform, by the processor, wherein the stress score indicates a level of job-related stress for the CSR; transmits the stress score for the CSR to the remote server for storage and use, via the communication device; and when the stress score indicates a high level of job-related stress for the CSR, the method causes stress mitigation functions to be performed, by the processor, the stress mitigation functions being associated with case assignments, case routing, and mindfulness module data, via communication connections to the console computer system, the customer service computer network, and the remote server.

Some embodiments of the present disclosure provide a system for providing monitoring and mitigating job-related stress for a customer service representative (CSR) using a console computer system in a customer service computer network. The system includes: a system memory element; a communication device, configured to establish communication connections to at least the console computer system, the customer service computer network, and a remote server that stores a Customer Relationship Management (CRM) software platform that collects and stores stress metrics; and at least one processor, communicatively coupled to the system memory element and the communication device, the at least one processor configured to: obtain a set of the stress metrics associated with the CSR, via the communication device, the set of the stress metrics comprising at least a quantity of cases assigned to the CSR, a second quantity of escalated cases assigned to the CSR, and a third quantity of case milestone violations associated with the CSR; compute a stress score for the CSR, based on the set of the stress metrics from the CRM software platform, wherein the stress score indicates a level of job-related stress for the CSR; transmit the stress score for the CSR to the remote server for storage and use; and when the stress score indicates a high level of job-related stress for the CSR, the system causes stress mitigation functions to be performed, the stress mitigation functions being associated with case assignments, case routing, and mindfulness module data, via the communication connections to the console computer system, the customer service computer network, and the remote server.

Some embodiments of the present disclosure provide a non-transitory, computer-readable medium containing instructions thereon, which, when executed by a processor, are capable of performing a method for providing monitoring and mitigating job-related stress for a customer service representative (CSR) using a console computer system in a customer service computer network. The method establishes communication connections to at least the console computer system, the customer service computer network, and a remote server that stores a Customer Relationship Management (CRM) software platform that collects and stores stress metrics, by a communication device communicatively coupled to the processor; obtains a set of the stress metrics associated with the CSR, via the communication device, the set of the stress metrics comprising at least a quantity of cases assigned to the CSR, a second quantity of escalated cases assigned to the CSR, and a third quantity of case milestone violations associated with the CSR; computes a stress score for the CSR, based on the set of the stress metrics from the CRM software platform, wherein the stress score indicates a level of job-related stress for the CSR; transmits the stress score for the CSR to the remote server for storage and use; and when the stress score indicates a high level of job-related stress for the CSR, the method causes stress mitigation functions to be performed, the stress mitigation functions being associated with case assignments, case routing, and mindfulness module data, via the communication connections to the console computer system, the customer service computer network, and the remote server.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a diagram of a stress monitoring and mitigation system, in accordance with the disclosed embodiments;

FIG. 2 is a functional block diagram of a server system, in accordance with the disclosed embodiments;

FIG. 3 is a functional block diagram of a computer system, in accordance with the disclosed embodiments;

FIG. 4 is a flow chart that illustrates an embodiment of a process for monitoring and mitigating job-related stress for a customer service representative (CSR) using a console computer system in a customer service computer network, in accordance with the disclosed embodiments;

FIG. 5 is a flow chart that illustrates an embodiment of a process for obtaining a set of stress metrics associated with a customer service representative (CSR), in accordance with the disclosed embodiments;

FIG. 6 is a flow chart that illustrates an embodiment of a process for providing stress score data for the customer service computer network; and

FIG. 7 is a conceptual block diagram of a multi-tenant system in accordance with one embodiment.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following

### DETAILED DESCRIPTION

The subject matter presented herein relates to systems and methods for monitoring and mitigating job-related stress for a customer service representative (CSR), salesperson, or other agent using a console computer system in a customer service computer network. More specifically, the subject matter relates to computing a stress score for a particular CSR, based on a plurality of “stress metrics” that quantify stressful situations that the CSR has encountered during a period of time wherein the CSR is logged into the console computer system, receiving customer communications, and resolving issues raised by the customer communications. The stress score is used to provide stress-reducing recommendations to the CSR, including recommending particular mindfulness tasks for the CSR to complete. Mindfulness tasks are integrated into modules of a Customer Relationship Management (CRM) software platform used by the CSR to perform typical customer service work.

Certain terminologies are used with regard to the various embodiments of the present disclosure. A CSR is a customer service representative, salesperson, or other type of agent working in a customer service environment (e.g., a call center, a customer service center). As used herein, a CSR is typically logged in and using a console computer system that is included as part of a customer service computer network. Stress metrics may include any quantifiable job condition associated with performing customer service and job-related tasks, which correlates to a heavier workload for a CSR and therefore a higher level of job-related stress for the CSR. In other words, stress metrics provide a measurable parameter that may be used to calculate stress score based on a current set of working conditions for the CSR. A stress score is a calculated, numerical description of a stress level for a particular CSR, based on the current set of working conditions for the CSR. Mindfulness tasks include action items for completion to lower the stress level of a CSR during the workday. Mindfulness tasks may include, without limitation: completing a guided meditation, taking a break from work and/or from a desk/workstation for a particular period of time, listening to relaxing music for a period of time, or any other task associated with relaxation or improving presence of mind.

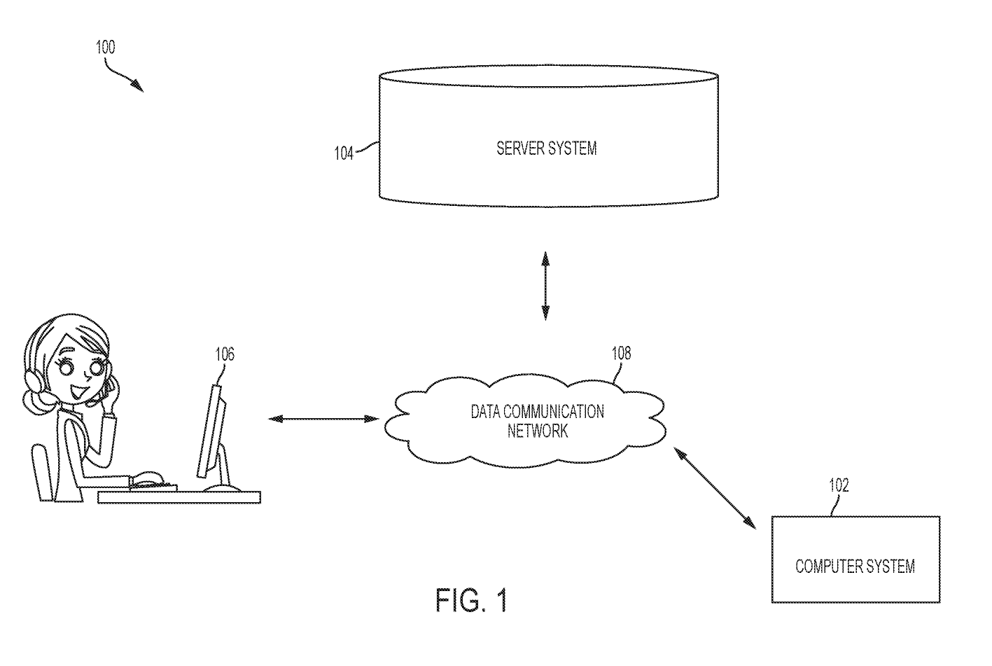

Turning now to the figures, FIG. 1 is a diagram of a stress monitoring and mitigation system 100, in accordance with the disclosed embodiments. As shown, the stress monitoring and mitigation system 100 includes a computer system 102 with the capability to communicate, via a data communication network 108, with a server system 104 and a console computer system 106 of a customer service computer network, wherein the console computer system 106 is generally operated by a customer service representative (CSR) to receive customer communications and to perform customer service activities. It should be appreciated that the computer system 102, the server system 104, and the console computer system 106, and any corresponding logical elements, individually or in combination, are exemplary means for performing a claimed function. In practice, an embodiment of the stress monitoring and mitigation system 100 may include additional or alternative elements and components, as desired for the particular application, without departing from the scope of the present disclosure.

The computer system 102 may be implemented by any computing device that includes at least one processor, some form of memory hardware, a user interface, and communication hardware, such that a user may communicate with the server system 104 and/or the console computer system 106. The computer system 102 is capable of communicating with a server system 104 and the console computer system 106 via a data communication network 108. The computer system 102 and the server system 104 are generally disparately located. The computer system 102 is configured to obtain stress metrics associated with a particular CSR from the server system 104, and to initiate the transmission of mindfulness modules from the server system 104 to the console computer system 106, for completion by the CSR.

The computer system 102 is capable of communicating with a server system 104 via a data communication network 108. The data communication network 108 may be any digital or other communications network capable of transmitting messages or data between devices, systems, or components. In certain embodiments, the data communication network 108 includes a packet switched network that facilitates packet-based data communication, addressing, and data routing. The packet switched network could be, for example, a wide area network, the Internet, or the like. In various embodiments, the data communication network 108 includes any number of public or private data connections, links or network connections supporting any number of communications protocols. The data communication network 108 may include the Internet, for example, or any other network based upon TCP/IP or other conventional protocols. In various embodiments, the data communication network 108 could also incorporate a wireless and/or wired telephone network, such as a cellular communications network for communicating with mobile phones, personal digital assistants, and/or the like. The data communication network 108 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol. For the sake of brevity, conventional techniques related to data transmission, signaling, network control, and other functional aspects of the systems (and the individual operating components of the systems) may not be described in detail herein.

The server system 104 may include any number of application servers, and each server may be implemented using any suitable computer. In some embodiments, the server system 104 includes one or more dedicated computers. In some embodiments, the server system 104 includes one or more computers carrying out other functionality in addition to server operations. The server system is configured to store, maintain, and execute one or more software platforms and programs, such as a customer relationship management (CRM) software platform that stores customer data and customer interaction data, business information, sales data, marketing data, customer support data, employee data, vendor and partner relationship data, or the like. The CRM software platform also includes mindfulness functionality to present mindfulness tasks or activities to the CSR for completion during the workday. Mindfulness tasks include action items for completion to lower the stress level of a CSR during the workday. Mindfulness tasks may include, without limitation: completing a guided meditation, taking a break from work and/or from a desk/workstation for a particular period of time, listening to relaxing music for a period of time, or any other task associated with relaxation or improving presence of mind.

The console computer system 106, like the computer system 102, may be implemented by any computing device that includes at least one processor, some form of memory hardware, and a user interface, such that a customer service representative (CSR) may receive communications from the CRM software platform of the server system 104, including customer service data relevant to the job of the CSR along with mindfulness module data and recommendations for mindfulness tasks for completion.

During typical operation, the computer system 102 establishes a communication connection, via the data communication network 108, to the CRM software platform stored, maintained, and executed by the server system 104. The computer system 102 obtains stress metrics for a particular CSR (e.g., customer service representative, salesperson, or other type of agent) stored by the server system 104. The stress metrics were previously collected by the CRM software platform during interactions of the CSR with the CRM software platform, via the console computer system 106. The computer system 102 uses the obtained stress metrics to compute a stress score for the particular CSR, and the stress score indicates a current stress level of the CSR based on performance parameters and intensity of workload. The computer system 102 then performs operations to mitigate the stress level of the CSR indicated by the stress score, by providing recommendations for mindfulness tasks or modules appropriate to the CSR workload and stress level. Thus, the computer system 102 first monitors and identifies an increased stress level for a CSR, and second mitigates the increased stress level by recommending appropriate mindfulness tasks for the CSR.

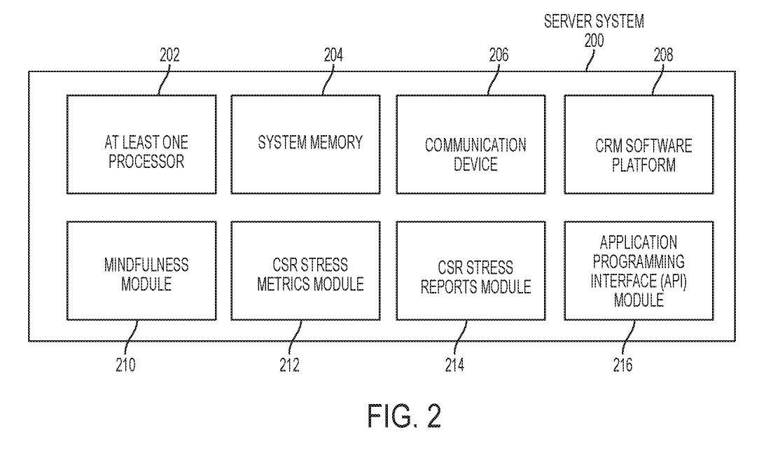

FIG. 2 is a functional block diagram of a server system 200, in accordance with the disclosed embodiments. It should be noted that the server system 200 can be implemented with the server system 104 depicted in FIG. 1. In this regard, the server system 200 shows certain elements and components of the server system 104 in more detail. The server system 200 generally includes, stores, maintains, operates, and/or executes, without limitation: at least one processor 202; system memory 204 hardware; a communication device 206; a Customer Relationship Management (CRM) software platform 208; a mindfulness module 210; a customer service representative (CSR) stress metrics module 212; a CSR stress reports module 214; and an application programming interface (API) module 216. These elements and features of server system 200 may be operatively associated with one another, coupled to one another, or otherwise configured to cooperate with one another as needed to support the desired functionality, as described herein. For ease of illustration and clarity, the various physical, electrical, and logical couplings and interconnections for these elements and features are not depicted in FIG. 2. Moreover, it should be appreciated that embodiments of the server system 200 will include other elements, modules, and features that cooperate to support the desired functionality. For simplicity, FIG. 2 only depicts certain elements that relate to the CSR job-related stress detection and mitigation techniques described in more detail below.

The at least one processor 202 may be implemented or performed with one or more general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In particular, the at least one processor 202 may be realized as one or more microprocessors, controllers, microcontrollers, or state machines. Moreover, the at least one processor 202 may be implemented as a combination of computing devices, e.g., a combination of digital signal processors and microprocessors, a plurality of microprocessors, one or more microprocessors in conjunction with a digital signal processor core, or any other such configuration.

The at least one processor 202 is communicatively coupled to, and communicates with, the system memory 204. The system memory 204 is configured to store any obtained or generated data associated with storing, maintaining, and executing a Customer Relationship Management (CRM) platform and associated customer service functionality and integrated mindfulness functionality. The system memory 204 may be realized using any number of devices, components, or modules, as appropriate to the embodiment. Moreover, the server system 200 could include system memory 204 integrated therein and/or a system memory 204 operatively coupled thereto, as appropriate to the particular embodiment. In practice, the system memory 204 could be realized as RAM memory, flash memory, EPROM memory, EEPROM memory, registers, a hard disk, a removable disk, or any other form of storage medium known in the art. In certain embodiments, the system memory 204 includes a hard disk, which may also be used to support functions of the server system 200. The system memory 204 can be coupled to the at least one processor 202 such that the at least one processor 202 can read information from, and write information to, the system memory 204. In the alternative, the system memory 204 may be integral to the at least one processor 202. As an example, the at least one processor 202 and the system memory 204 may reside in a suitably designed application-specific integrated circuit (ASIC).

The communication device 206 is suitably configured to communicate data between the server system 200 and one or more computer systems (e.g., computer system 102 of FIG. 1) and one or more console computer systems (e.g., console computer system 106 of FIG. 1). The communication device 206 may transmit and receive communications over a wireless local area network (WLAN), the Internet, a satellite uplink/downlink, a cellular network, a broadband network, a wide area network, or the like. As described in more detail below, data received by the communication device 206 may include, without limitation: data associated with performing customer service tasking and managing customer service cases, mindfulness module completion data, requests for CSR stress scores or stress score reports, requests for stress metrics associated with one or more CSRs, and other data compatible with the server system 200. Data provided by the communication device 206 may include, without limitation, data associated with performing customer service tasking and managing customer service cases, mindfulness module data for completion by a CSR, CSR stress scores or stress score reports, stress metrics associated with one or more CSRs, and the like.

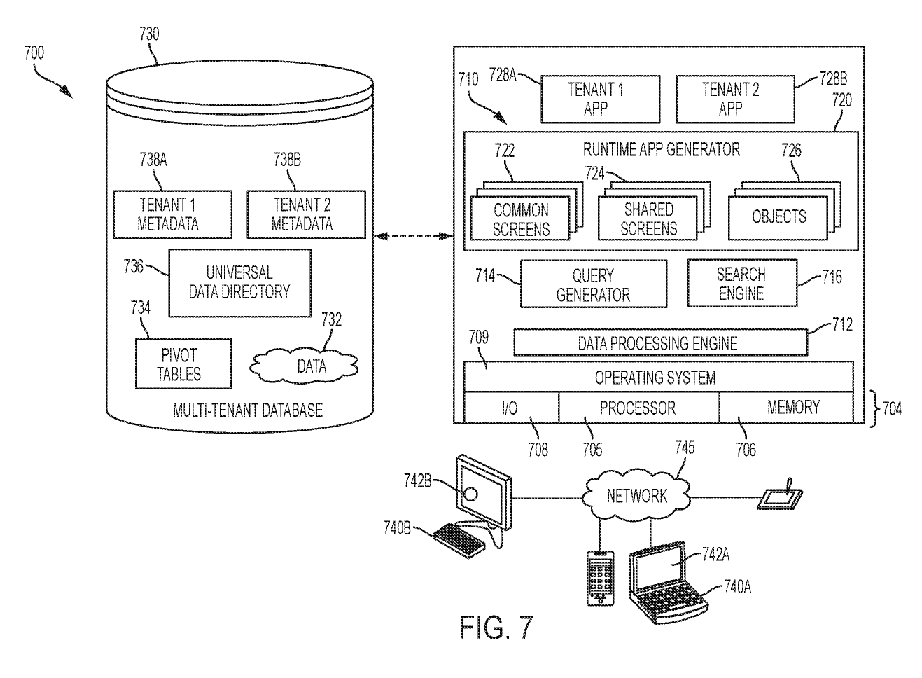

The Customer Relationship Management (CRM) software platform 208 may be implemented as part of an enterprise computing platform, which is configured to store customer data including ordering data, pricing data, shipping data, or the like. In certain embodiments, the CRM software platform 208 may be implemented by a multi-tenant database system, as described in more detail with regard to FIG. 7. The CRM software platform 208 may store customer data and customer interaction data, business information, sales data, marketing data, customer support data, employee data, vendor and partner relationship data, or the like. The CRM software platform 208 may also include functionality to manage customer data and customer interaction, access business information, automate sales, marketing and customer support and also manage employee, vendor and partner relationships. In addition to conventional CRM functionality, the CRM software platform 208 includes integrated mindfulness functionality (via the mindfulness module 210).

The mindfulness module 210 is configured to provide mindfulness data (via the CRM software platform 208) to a CSR that is logged into and using a console computer system that is part of a customer service computer network. The mindfulness module 210 presents recommendations for mindfulness modules and/or tasks for completion by a CSR. Mindfulness tasks include action items for completion to lower the stress level of a CSR during the workday. Mindfulness tasks may include, without limitation: completing a guided meditation, taking a break from work and/or from a desk/workstation for a particular period of time, listening to relaxing music for a period of time, or any other task associated with relaxation or improving presence of mind. The mindfulness module 210 is further configured to provide links and information associated with mindfulness tasks and mindfulness modules, and to receive user input to complete mindfulness modules and to generate completed mindfulness modules.

The customer service representative (CSR) stress metrics module 212 is configured to store and provide stress metrics associated with one or more CSRs. Stress metrics are parameters that are used to compute a stress score for the particular CSR, wherein the stress score indicates a current level of job-related stress or anxiety for the CSR based on current workload and working conditions. Stress metrics may include any quantifiable job condition associated with performing customer service and job-related tasks, which correlates to a heavier workload for a CSR and therefore a higher level of job-related stress for the CSR. In other words, stress metrics provide a measurable parameter that may be used to calculate stress score based on a current set of working conditions for the CSR. Stress metrics include a current quantity of customer service cases assigned to a CSR, a current quantity of escalated customer service cases assigned to the CSR, and/or a current quantity of case milestone violations associated with the CSR.

The CSR stress reports module 214 is configured to store and provide stress reporting for one or more CSRs of the customer service computer network that communicates with the server system 200. A stress score is a calculated, numerical description of a stress level for a particular CSR, based on the current set of working conditions for the CSR. The CSR stress reports module 214 may store and provide access to stress reports for one CSR for a period of time, or for multiple CSRs for a period of time. The CSR stress reports module 214 receives the generated reports from the computer system (see FIG. 1, reference 102), stores the reports, and permits access to the reports by users accessing the CRM software platform 208 of the server system 200.

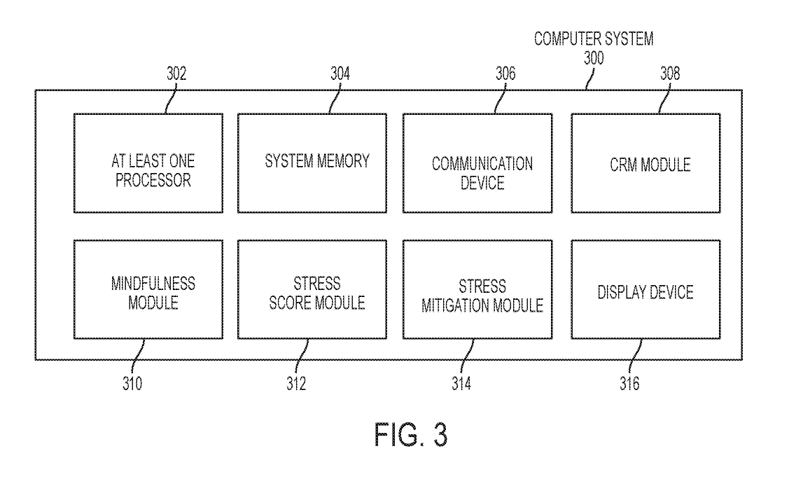

The application programming interface (API) module 216 is configured to establish a communication connection between the CRM software platform 208 and a mindfulness module, a stress score module, and a stress mitigation module of the computer system (see references 102 of FIG. 1 and reference 300 of FIG. 3). The API module 216 establishes the communication connection for purposes of receiving mindfulness module data, computed stress scores, and communications associated with stress mitigation functionality.

In practice, the CRM software platform 208, the mindfulness module 210, the CSR stress metrics module 212, the CSR stress reports module 214, and/or the application programming interface (API) module 216, may be implemented with (or cooperate with) the at least one processor 202 to perform at least some of the functions and operations described in more detail herein. In this regard, the CRM software platform 208, the mindfulness module 210, the CSR stress metrics module 212, the CSR stress reports module 214, and/or the application programming interface (API) module 216 may be realized as suitably written processing logic, application program code, or the like.

FIG. 3 is a functional block diagram of a computer system 300, in accordance with the disclosed embodiments. The computer system, 300 is configured for use, by a first user, to connect to and communicate with disparately located server systems executing a Customer Relationship Management (CRM) software application and/or a disparately located console computer system operated by a second user (e.g., a customer service terminal). It should be noted that the computer system 300 can be implemented with the computer system 102 depicted in FIG. 1. In this regard, the computer system 300 shows certain elements and components of the computer system 102 in more detail. The computer system 300 generally includes, without limitation: at least one processor 302; system memory 304 hardware; a communication device 306; a CRM module 308; a mindfulness module 310; a stress score module 312; a stress mitigation module 314; and a display device 316. The at least one processor 302, the system memory 304, and the communication device 306 are similar in configuration and function to their counterpart items described above in the context of the server system 200. Accordingly, common features and operations of these elements of the computer system 300 will not be redundantly described here.

The CRM module 308 is configured to communicate with the CRM software platform stored, maintained, and executed by one or more remote servers. The CRM module 308 provides an interface for the computer system 300 to provide data to, and to obtain data from, the CRM software platform. The CRM module 308 is configured to obtain stored stress metrics, stored CSR stress reports, stored CSR stress scores, and the like, from the CRM software platform. The CRM module 308 is configured to provide calculated stress scores, updated stress metrics (e.g., completed mindfulness module data), and the like.

The mindfulness module 310 obtains mindfulness data associated with a particular CSR (from a CSR console computer system, as shown in FIG. 1), and updates the CRM software platform with the mindfulness data and updated stress data. Each time a CSR completes a mindfulness task, the mindfulness module 310 updates the stress metrics associated with that particular CSR. The CSR stress metrics are indicators of a current workload and stress level of the CSR. Completion of mindfulness modules indicates a lower level of stress, and using the updated stress metrics (including the completion of mindfulness modules) lowers the stress score for a particular CSR. The mindfulness module 310 obtains completed mindfulness module data from the console computer system (used by a CSR) to generate completed mindfulness modules, and updates stress metrics stored and maintained by the CRM software platform with completed mindfulness module data.

The stress score module 312 is configured to compute stress scores for individual CSRs based on stress metrics obtained from the CRM software platform. The obtained stress metrics may include any quantifiable job condition associated with performing customer service and job-related tasks, which correlates to a heavier workload for a CSR and therefore a higher level of job-related stress for the CSR. In other words, stress metrics provide a measurable parameter that may be used to calculate stress score based on a current set of working conditions for the CSR. Stress metrics include a current quantity of customer service cases assigned to a CSR, a current quantity of escalated customer service cases assigned to the CSR, and/or a current quantity of case milestone violations associated with the CSR. The stress score is a calculated, numerical description of a stress level for a particular CSR, based on the current set of working conditions for the CSR. The stress score module 312 calculates a current stress score for one CSR based on the current workload and the current job-related conditions, and transmits the calculated stress score to the CRM software platform (stored and maintained by a remotely located server) for future use.

The stress mitigation module 314 is configured to perform stress mitigation tasks when job-related stress is high for a particular CSR. As described herein, a high level of job-related stress is indicated by a high stress score. Based on the stress score (calculated by the stress score module 312), the stress mitigation module 314 determines whether a particular CSR is experiencing a high level of job-related stress, and performs stress mitigation operations to lower the job-related stress level and the associated stress score. The CSR uses a console computer system to communicate with customers, to perform tasking associated with customer service, and to communicate with the CRM software platform. The console computer system is communicatively coupled to the computer system 300 and one or more remotely located servers via a customer service computer network (as described with regard to FIG. 1). The stress mitigation module 314 of the computer system 300 performs the stress mitigation tasks via the customer service computer network. Stress mitigation tasks may include, without limitation: automatically re-routing high-priority cases to a second CSR with a lower stress score, via the customer service computer network; automatically reducing a quantity of cases in a queue for the CSR, via the customer service computer network; automatically transmitting a notification to the CSR (via customer service computer network and to the console computer system) wherein the notification includes a recommendation for a mindfulness module for the CSR to complete; and the like.

The display device 316 is configured to display various icons, text, and/or graphical elements associated with a CRM software platform, integrated mindfulness functionality, CSR stress scores or stress score reports, or the like. In an exemplary embodiment, the display device 316 is communicatively coupled to the at least one processor 302. The at least one processor 302 and the display device 316 are cooperatively configured to display, render, or otherwise convey one or more graphical representations or images associated with the CRM software platform and integrated mindfulness functionality on the display device 316, as described in greater detail below. In an exemplary embodiment, the display device 316 is realized as an electronic display, as described herein. In some embodiments, the display device 316 is implemented as a display screen of a standalone, personal computing device (e.g., laptop computer, tablet computer). It will be appreciated that although the display device 316 may be implemented using a single display, certain embodiments may use additional displays (i.e., a plurality of displays) to accomplish the functionality of the display device 316 described herein.

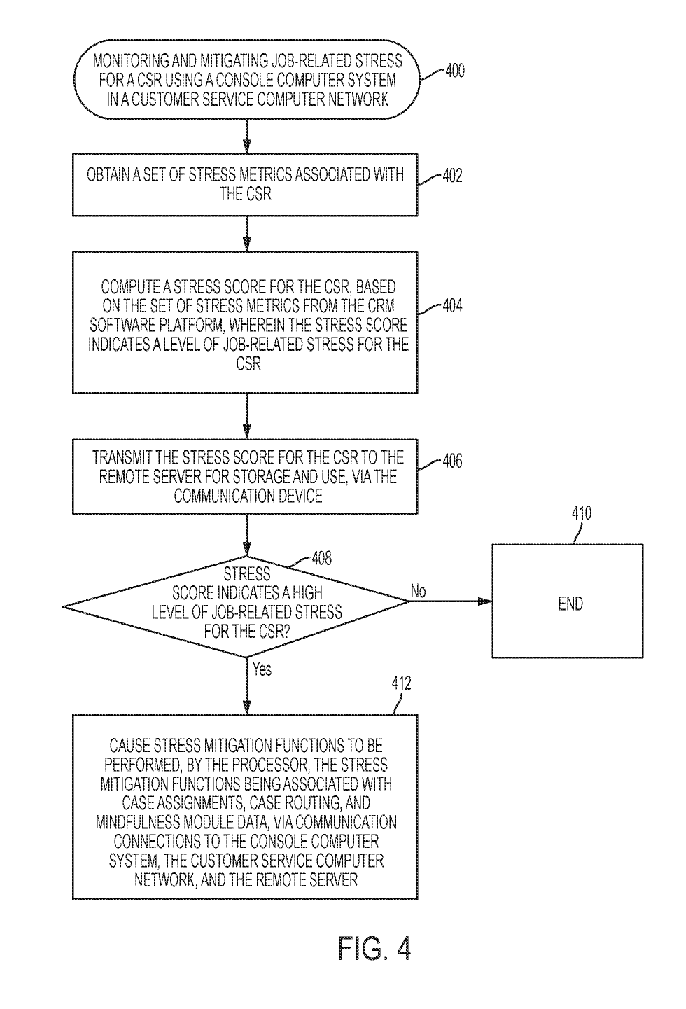

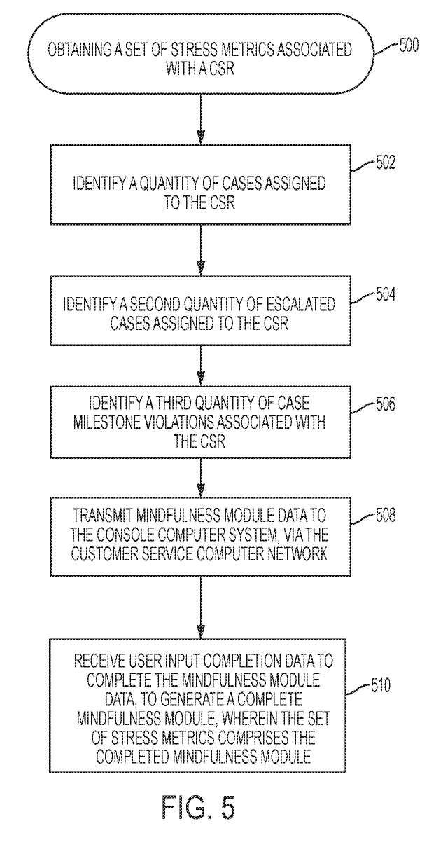

FIG. 4 is a flow chart that illustrates an embodiment of a process 400 for monitoring and mitigating job-related stress for a customer service representative (CSR) using a console computer system in a customer service computer network, in accordance with the disclosed embodiments. First, the process 400 obtains a set of stress metrics associated with the CSR (step 402). One exemplary embodiment of obtaining a set of stress metrics is described below with regard to FIG. 5, including additional detail. Stress metrics may include any quantifiable job condition associated with performing customer service and job-related tasks, which correlates to a heavier workload for a CSR and therefore a higher level of job-related stress for the CSR. In other words, stress metrics provide a measurable parameter that may be used to calculate stress score based on a current set of working conditions for the CSR.

Next, the process 400 computes a stress score for the CSR, based on the set of stress metrics from the CRM software platform, wherein the stress score indicates a level of job-related stress for the CSR (step 404). Here, the process 400 correlates a heavy workload for the CSR with a high level of job-related stress.

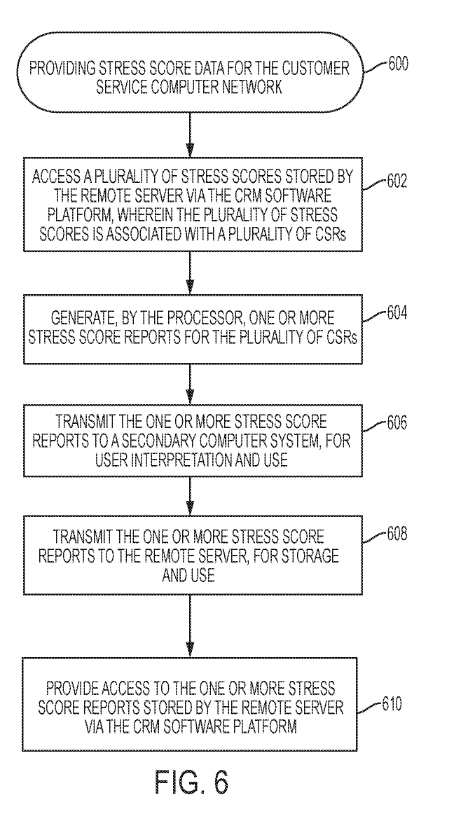

The process 400 then transmits the stress score for the CSR to the remote server for storage and use, via the communication device (step 406). As described with regard to FIG. 6, stress scores for one or more CSRs are stored by a remote server such that the stress scores may be accessed later for decision-making purposes within the customer service computer network environment.

The process 400 then determines whether the stress score for the CSR indicates a high level of job-related stress for the CSR (decision 408). Generally, the stress score is compared to a predefined threshold. A stress score lower than the predefined threshold indicates a high level of job-related stress for the CSR, and a stress score that is greater than or equal to the predefined threshold does not indicate a high level of job-related stress for the CSR.

When the stress score for the CSR does not indicate a high level of job-related stress for the CSR (the “No” branch of 408), then the process 400 ends (step 410). However, when the stress score for the CSR indicates a high level of job-related stress for the CSR (the “Yes” branch of 408), then the process 400 causes stress mitigation functions to be performed, by the processor (step 410). The stress mitigation functions are associated with case assignments, case routing, and mindfulness module data, and the stress mitigation functions are performed by the processor via communication connections to the console computer system, the customer service computer network, and the remote server.

In some embodiments, when the stress score is greater than or equal to the predefined threshold, the process 400 identifies a high priority case transmitted to the console computer system for handling by the CSR; and automatically re-routes the high priority case to a second CSR associated with a stress score less than the predefined threshold, via the customer service computer network, wherein the stress mitigation functions comprise at least automatically re-routing the high priority case. In some embodiments, when the stress score is greater than or equal to the predefined threshold, automatically reduces a quantity of cases in a queue for the console computer system associated with the CSR, by re-routing a subset of the quantity to one or more CSRs associated with stress scores lower than the predefined threshold, via the customer service computer network, wherein the stress mitigation functions comprise at least automatically reducing the quantity of cases in the queue. In some embodiments, when the stress score is greater than or equal to the predefined threshold, the process 400 automatically transmits a notification to the console computer system for presentation to the CSR, via the customer service computer network, wherein the notification includes a recommended mindfulness module for completion to reduce the stress score, and wherein the stress mitigation functions comprise at least automatically transmitting the notification.

FIG. 5 is a flow chart that illustrates an embodiment of a process 500 for obtaining a set of stress metrics associated with a customer service representative (CSR), in accordance with the disclosed embodiments. It should be appreciated that the process 500 of FIG. 5 represents one embodiment of step 402 of FIG. 4, as described previously, and including additional detail.

First, the process 500 identifies a quantity of cases assigned to the CSR (step 502). The process 500 obtains data associated with case assignments for one particular CSR from the Customer Relationship Management (CRM) software platform that is used by the CSR to perform customer service, job-related tasks. The number of cases assigned to the CSR is an indicator of a stress level of the CSR. A particular number of cases (i.e., a case quantity threshold) may indicate a heavy workload for the CSR. Thus, the quantity of cases assigned to the CSR is included in the stress metrics for the CSR.

Next, the process 500 identifies a second quantity of escalated cases assigned to the CSR (step 504). The process 500 obtains data associated with escalated case assignments for one particular CSR from the CRM software platform. The number of escalated cases assigned to the CSR is an indicator of a stress level of the CSR. Cases that are urgent or high-priority indicate an immediate need for attention from the CSR, and thus the quantity of escalated cases is included in the stress metrics for the CSR.

The process 500 then identifies a third quantity of case milestone violations associated with the CSR (step 506). The process 500 obtains data associated with case milestone violations for one particular CSR from the CRM software platform. Each case has “milestones” or particular tasks that are scheduled for completion at a particular time or date. A case milestone violation occurs when the deadline for particular tasks, associated with a particular case, is not met. The number of case milestone violations associated with the CSR is an indicator of a stress level of the CSR. Cases have missed milestones indicate an immediate need for attention from the CSR, and thus the quantity of case milestone violations is included in the stress metrics for the CSR.

The process 500 also transmits mindfulness module data to the console computer system, via the customer service computer network (step 508), for completion by the CSR. The process 500 then receives user input completion data to complete the mindfulness module data, to generate a complete mindfulness module (step 510). As described previously, the stress score indicates a current level of job-related stress associated with a particular CSR, and completed mindfulness modules are used to reduce the stress score and the associated current stress level of the CSR. Here, the set of stress metrics includes the completed mindfulness module.

Stress metrics may include, without limitation: a quantity of cases assigned to the CSR, a quantity of escalated cases assigned to the CSR, a quantity of case milestone violations associated with the CSR, and the like. Each CSR handles a workload that includes a number of cases associated with customers or customer issues. A heavy workload for a CSR may include an increased number of cases that the CSR is handling, an increased number of escalated cases for the CSR, and/or an increased number of case milestone violations.

FIG. 6 is a flow chart that illustrates an embodiment of a process 600 for providing stress score data for the customer service computer network. Stress scores for a particular customer service representative (CSR), or for a plurality of CSRs, may be stored and/or transmitted for interpretation and use in a customer service environment. Stress score data may be used to determine case assignments, case routing, or the like.

First, the process 600 accesses a plurality of stress scores stored by the remote server via the Customer Relationship Management (CRM) software platform (step 602), wherein the plurality of stress scores is associated with a plurality of customer service representatives (CSRs). Next, the process 600 generates, by the processor, one or more stress score reports for the plurality of CSRs (step 604).

Stress scores for individual CSRs provides a summary of workload and stress level for one particular CSR, while stress score reports provide a more complete summary of workload and stress level for groups of CSRs. In one example, the process 600 generates stress score reports for CSRs working in one particular customer service center location. As another example, the process 600 generates stress score reports for a subset of CSRs working in one particular customer service center location.

The process 600 then transmits the one or more stress score reports to a secondary computer system, for user interpretation and use (step 606). In this step, the process 600 transmits the stress score reports to one particular computer system for user viewing, interpretation, and potential use in decision-making.

In certain embodiments, the process 600 transmits the one or more stress score reports to the remote server, for storage and use (step 608), and then the process 600 provides access to the one or more stress score reports stored by the remote server via the CRM software platform (step 610). Here, the process 600 stores the stress score reports and permits particular users to access the stress score reports when required.

FIG. 7 is a conceptual block diagram of a multi-tenant system 700 in accordance with the disclosed embodiments. The multi-tenant system 700 may be used to in conjunction with the CRM software applications described previously. Platform as a Service (PaaS) is the foundation of the multi-tenant architecture. At the heart, this PaaS is a relational database management system. All of the core mechanisms in a relational database management system (RDBMS) (e.g., a system catalog, caching mechanisms, query optimizer, and application development features) are built to support multi-tenant applications and to be run directly on top of a specifically tuned host operating system and raw hardware. The runtime engine has the intelligence to access the metadata and transactional data and perform the application functionality that can scale.

The multi-tenant system 700 of FIG. 7 includes a server 702 that dynamically creates and supports virtual applications 728 based upon data 732 from a common database 730 that is shared between multiple tenants, alternatively referred to herein as a multi-tenant database. Data and services generated by the virtual applications 728 are provided via a network 745 to any number of client devices 740, as desired. Each virtual application 728 is suitably generated at run-time (or on-demand) using a common application platform 710 that securely provides access to the data 732 in the database 730 for each of the various tenants subscribing to the multi-tenant system 700. In accordance with one non-limiting example, the multi-tenant system 700 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 730. In this regard, each tenant includes one or more users associated with, assigned to, or otherwise belonging to that respective tenant. To put it another way, each respective user within the multi-tenant system 700 is associated with, assigned to, or otherwise belongs to a particular tenant of the plurality of tenants supported by the multi-tenant system 700. Tenants may represent customers, customer departments, business or legal organizations, and/or any other entities that maintain data for particular sets of users within the multi-tenant system 700 (i.e., in the multi-tenant database 730). For example, the application server 702 may be associated with one or more tenants supported by the multi-tenant system 700. Although multiple tenants may share access to the server 702 and the database 730, the particular data and services provided from the server 702 to each tenant can be securely isolated from those provided to other tenants (e.g., by restricting other tenants from accessing a particular tenant's data using that tenant's unique organization identifier as a filtering criterion). The multi-tenant architecture therefore allows different sets of users to share functionality and hardware resources without necessarily sharing any of the data 732 belonging to or otherwise associated with other tenants.

The multi-tenant database 730 is any sort of repository or other data storage system capable of storing and managing the data 732 associated with any number of tenants. The database 730 may be implemented using any type of conventional database server hardware. In various embodiments, the database 730 shares processing hardware 704 with the server 702. In other embodiments, the database 730 is implemented using separate physical and/or virtual database server hardware that communicates with the server 702 to perform the various functions described herein. In an exemplary embodiment, the database 730 includes a database management system or other equivalent software capable of determining an optimal query plan for retrieving and providing a particular subset of the data 732 to an instance of virtual application 728 in response to a query initiated or otherwise provided by a virtual application 728. The multi-tenant database 730 may alternatively be referred to herein as an on-demand database, in that the multi-tenant database 730 provides (or is available to provide) data at run-time to on-demand virtual applications 728 generated by the application platform 710.

In practice, the data 732 may be organized and formatted in any manner to support the application platform 710. In various embodiments, the data 732 is suitably organized into a relatively small number of large data tables to maintain a semi-amorphous “heap”-type format. The data 732 can then be organized as needed for a particular virtual application 728. In various embodiments, conventional data relationships are established using any number of pivot tables 734 that establish indexing, uniqueness, relationships between entities, and/or other aspects of conventional database organization as desired. Further data manipulation and report formatting is generally performed at run-time using a variety of metadata constructs. Metadata within a universal data directory (UDD) 736, for example, can be used to describe any number of forms, reports, workflows, user access privileges, business logic and other constructs that are common to multiple tenants. Tenant-specific formatting, functions and other constructs may be maintained as tenant-specific metadata 738 for each tenant, as desired. Rather than forcing the data 732 into an inflexible global structure that is common to all tenants and applications, the database 730 is organized to be relatively amorphous, with the pivot tables 734 and the metadata 738 providing additional structure on an as-needed basis. To that end, the application platform 710 suitably uses the pivot tables 734 and/or the metadata 738 to generate “virtual” components of the virtual applications 728 to logically obtain, process, and present the relatively amorphous data 732 from the database 730.

The server 702 is implemented using one or more actual and/or virtual computing systems that collectively provide the dynamic application platform 710 for generating the virtual applications 728. For example, the server 702 may be implemented using a cluster of actual and/or virtual servers operating in conjunction with each other, typically in association with conventional network communications, cluster management, load balancing and other features as appropriate. The server 702 operates with any sort of conventional processing hardware 704, such as a processor 705, memory 706, input/output features 708 and the like. The input/output features 708 generally represent the interface(s) to networks (e.g., to the network 745, or any other local area, wide area or other network), mass storage, display devices, data entry devices and/or the like. The processor 705 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 706 represents any non-transitory short or long term storage or other computer-readable media capable of storing programming instructions for execution on the processor 705, including any sort of random access memory (RAM), read only memory (ROM), flash memory, magnetic or optical mass storage, and/or the like. The computer-executable programming instructions, when read and executed by the server 702 and/or processor 705, cause the server 702 and/or processor 705 to create, generate, or otherwise facilitate the application platform 710 and/or virtual applications 728 and perform one or more additional tasks, operations, functions, and/or processes described herein. It should be noted that the memory 706 represents one suitable implementation of such computer-readable media, and alternatively or additionally, the server 702 could receive and cooperate with external computer-readable media that is realized as a portable or mobile component or application platform, e.g., a portable hard drive, a USB flash drive, an optical disc, or the like.

The application platform 710 is any sort of software application or other data processing engine that generates the virtual applications 728 that provide data and/or services to the client devices 740. In a typical embodiment, the application platform 710 gains access to processing resources, communications interfaces and other features of the processing hardware 704 using any sort of conventional or proprietary operating system 709. The virtual applications 728 are typically generated at run-time in response to input received from the client devices 740. For the illustrated embodiment, the application platform 710 includes a bulk data processing engine 712, a query generator 714, a search engine 716 that provides text indexing and other search functionality, and a runtime application generator 720. Each of these features may be implemented as a separate process or other module, and many equivalent embodiments could include different and/or additional features, components or other modules as desired.

The runtime application generator 720 dynamically builds and executes the virtual applications 728 in response to specific requests received from the client devices 740. The virtual applications 728 are typically constructed in accordance with the tenant-specific metadata 738, which describes the particular tables, reports, interfaces and/or other features of the particular application 728. In various embodiments, each virtual application 728 generates dynamic web content that can be served to a browser or other client program 742 associated with its client device 740, as appropriate.

The runtime application generator 720 suitably interacts with the query generator 714 to efficiently obtain multi-tenant data 732 from the database 730 as needed in response to input queries initiated or otherwise provided by users of the client devices 740. In a typical embodiment, the query generator 714 considers the identity of the user requesting a particular function (along with the user's associated tenant), and then builds and executes queries to the database 730 using system-wide metadata 736, tenant specific metadata 738, pivot tables 734, and/or any other available resources. The query generator 714 in this example therefore maintains security of the common database 730 by ensuring that queries are consistent with access privileges granted to the user and/or tenant that initiated the request. In this manner, the query generator 714 suitably obtains requested subsets of data 732 accessible to a user and/or tenant from the database 730 as needed to populate the tables, reports or other features of the particular virtual application 728 for that user and/or tenant.

Still referring to FIG. 7, the data processing engine 712 performs bulk processing operations on the data 732 such as uploads or downloads, updates, online transaction processing, and/or the like. In many embodiments, less urgent bulk processing of the data 732 can be scheduled to occur as processing resources become available, thereby giving priority to more urgent data processing by the query generator 714, the search engine 716, the virtual applications 728, etc.

In exemplary embodiments, the application platform 710 is utilized to create and/or generate data-driven virtual applications 728 for the tenants that they support. Such virtual applications 728 may make use of interface features such as custom (or tenant-specific) screens 724, standard (or universal) screens 722 or the like. Any number of custom and/or standard objects 726 may also be available for integration into tenant-developed virtual applications 728. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. For example, a virtual CRM application may utilize standard objects 726 such as “account” objects, “opportunity” objects, “contact” objects, or the like. The data 732 associated with each virtual application 728 is provided to the database 730, as appropriate, and stored until it is requested or is otherwise needed, along with the metadata 738 that describes the particular features (e.g., reports, tables, functions, objects, fields, formulas, code, etc.) of that particular virtual application 728. For example, a virtual application 728 may include a number of objects 726 accessible to a tenant, wherein for each object 726 accessible to the tenant, information pertaining to its object type along with values for various fields associated with that respective object type are maintained as metadata 738 in the database 730. In this regard, the object type defines the structure (e.g., the formatting, functions and other constructs) of each respective object 726 and the various fields associated therewith.

Still referring to FIG. 7, the data and services provided by the server 702 can be retrieved using any sort of personal computer, mobile telephone, tablet or other network-enabled client device 740 on the network 745. In an exemplary embodiment, the client device 740 includes a display device, such as a monitor, screen, or another conventional electronic display capable of graphically presenting data and/or information retrieved from the multi-tenant database 730. Typically, the user operates a conventional browser application or other client program 742 executed by the client device 740 to contact the server 702 via the network 745 using a networking protocol, such as the hypertext transport protocol (HTTP) or the like. The user typically authenticates his or her identity to the server 702 to obtain a session identifier (“SessionlD”) that identifies the user in subsequent communications with the server 702. When the identified user requests access to a virtual application 728, the runtime application generator 720 suitably creates the application at run time based upon the metadata 738, as appropriate. As noted above, the virtual application 728 may contain Java, ActiveX, or other content that can be presented using conventional client software running on the client device 740; other embodiments may simply provide dynamic web or other content that can be presented and viewed by the user, as desired.

The various tasks performed in connection with processes 400-600 may be performed by software, hardware, firmware, or any combination thereof. For illustrative purposes, the preceding descriptions of processes 400-600 may refer to elements mentioned above in connection with FIGS. 1-3. In practice, portions of processes 400-600 may be performed by different elements of the described system. It should be appreciated that processes 400-600 may include any number of additional or alternative tasks, the tasks shown in FIGS. 4-6 need not be performed in the illustrated order, and processes 400-600 may be incorporated into a more comprehensive procedure or process having additional functionality not described in detail herein. Moreover, one or more of the tasks shown in FIGS. 4-6 could be omitted from embodiments of the processes 400-600 as long as the intended overall functionality remains intact.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The preceding description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematic shown in FIGS. 2-3 depict exemplary arrangements of elements, additional intervening elements, devices, features, or components may be present in embodiments of the depicted subject matter.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for monitoring and mitigating job-related stress for a customer service representative (CSR) using a console computer system in a customer service computer network, the method comprising:
obtaining a set of stress metrics associated with the CSR, from a remote server configured to store a Customer Relationship Management (CRM) software platform, via a communication device communicatively coupled to a processor of the customer service computer network, the set of stress metrics comprising at least a quantity of cases assigned to the CSR, a second quantity of escalated cases assigned to the CSR, and a third quantity of case milestone violations associated with the CSR;
computing a stress score for the CSR based on the set of stress metrics from the CRM software platform, by the processor, wherein the stress score indicates a level of job-related stress for the CSR;
transmitting the stress score for the CSR to the remote server for storage and use, via the communication device; and
when the stress score indicates a high level of job-related stress for the CSR, causing stress mitigation functions to be performed, by the processor, the stress mitigation functions being associated with case assignments, case routing, and mindfulness module data, via communication connections to the console computer system, the customer service computer network, and the remote server.

2. The method of claim 1, further comprising:
transmitting mindfulness module data to the console computer system, by the processor via the communication device;
receiving user input completion data to complete the mindfulness module data, via the communication connections, to generate a complete mindfulness module, wherein the set of stress metrics comprises the complete mindfulness module.

3. The method of claim 1, further comprising:
accessing a plurality of stress scores stored by the remote server via the CRM software platform, wherein the set of stress metrics comprise at least the plurality of stress scores, and wherein the plurality of stress scores is associated with a plurality of CSRs;
generating, by the processor, one or more stress score reports for the plurality of CSRs;
transmit, via the communication device, the one or more stress score reports to the remote server for storage and use; and
provide access to the one or more stress score reports, via the CRM software platform.

4. The method of claim 1, further comprising:
accessing a plurality of stress scores stored at the remote server via the CRM software platform, by the processor, wherein the set of stress metrics comprise at least the plurality of stress scores, and wherein the plurality of stress scores are associated with a plurality of CSRs;
generating one or more stress score reports for the plurality of CSRs, by the processor; and
transmitting the one or more stress score reports, via the communication device, to a secondary computer system for user interpretation and use.

5. The method of claim 1, further comprising:
comparing the stress score for the CSR to a predefined threshold, by the processor; and
when the stress score is greater than the predefined threshold,
identifying a high priority case transmitted to the console computer system for handling by the CSR; and
automatically re-routing the high priority case to a second CSR associated with a stress score less than the predefined threshold, via the customer service computer network, wherein the stress mitigation functions comprise at least automatically re-routing the high priority case.

6. The method of claim 1, further comprising:
comparing the stress score for the CSR to a predefined threshold, by the processor; and
when the stress score is greater than the predefined threshold,
automatically reducing a quantity of cases in a queue for the console computer system associated with the CSR, by re-routing a subset of the quantity to one or more CSRs associated with stress scores lower than the predefined threshold, via the customer service computer network, wherein the stress mitigation functions comprise at least automatically reducing the quantity of cases in the queue.

7. The method of claim 1, further comprising:
compare the stress score for the CSR to a predefined threshold, by the processor; and
when the stress score is greater than the predefined threshold,
automatically transmitting a notification to the console computer system for presentation to the CSR, via the customer service computer network, wherein the notification includes a recommended mindfulness module for completion to reduce the stress score, and wherein the stress mitigation functions comprise at least automatically transmitting the notification.

8. A system for providing monitoring and mitigating job-related stress for a customer service representative (CSR) using a console computer system in a customer service computer network, the system comprising:
a system memory element;
a communication device, configured to establish communication connections to at least the console computer system, the customer service computer network, and a remote server that stores a Customer Relationship Management (CRM) software platform that collects and stores stress metrics; and
at least one processor, communicatively coupled to the system memory element and the communication device, the at least one processor configured to:
obtain a set of the stress metrics associated with the CSR, via the communication device, the set of the stress metrics comprising at least a quantity of cases assigned to the CSR, a second quantity of escalated cases assigned to the CSR, and a third quantity of case milestone violations associated with the CSR;
compute a stress score for the CSR, based on the set of the stress metrics from the CRM software platform, wherein the stress score indicates a level of job-related stress for the CSR;
transmit the stress score for the CSR to the remote server for storage and use; and
when the stress score indicates a high level of job-related stress for the CSR, causing stress mitigation functions to be performed, the stress mitigation functions being associated with case assignments, case routing, and mindfulness module data, via the communication connections to the console computer system, the customer service computer network, and the remote server.

9. The system of claim 8, wherein the at least one processor is further configured to:
transmit mindfulness module data to the console computer system, via the communication device;
receive user input completion data to complete the mindfulness module data, via the communication connections, to generate a complete mindfulness module, wherein the set of the stress metrics comprises the complete mindfulness module.

10. The system of claim 8, wherein the at least one processor is further configured to:
access a plurality of stress scores stored at the remote server via the CRM software platform, wherein the stress metrics comprise at least the plurality of stress scores, and wherein the plurality of stress scores are associated with a plurality of CSRs;
generate one or more stress score reports for the plurality of CSRs;
transmit the one or more stress score reports to the remote server for storage and use; and
provide access to the one or more stress score reports, via the CRM software platform.

11. The system of claim 8, wherein the at least one processor is further configured to:
access a plurality of stress scores stored at the remote server via the CRM software platform, wherein the stress metrics comprise at least the plurality of stress scores, and wherein the plurality of stress scores are associated with a plurality of CSRs;
generate one or more stress score reports for the plurality of CSRs; and
transmit the one or more stress score reports, via the communication device, to a secondary computer system for user interpretation and future use.

12. The system of claim 8, wherein the at least one processor is further configured to:
compare the stress score for the CSR to a predefined threshold; and
when the stress score is greater than the predefined threshold,
identify a high priority case transmitted to the console computer system for handling by the CSR; and
automatically re-route the high priority case to a second CSR associated with a stress score less than the predefined threshold, wherein the stress mitigation functions comprise at least automatically re-routing the high priority case.

13. The system of claim 8, wherein the at least one processor is further configured to:
compare the stress score for the CSR to a predefined threshold; and
when the stress score is greater than the predefined threshold,
automatically reduce a quantity of cases in a queue for the console computer system associated with the CSR, by re-routing a subset of the quantity to one or more CSRs associated with stress scores lower than the predefined threshold, wherein the stress mitigation functions comprise at least automatically reducing the quantity of cases in the queue.

14. The system of claim 8, wherein the at least one processor is further configured to:
compare the stress score for the CSR to a predefined threshold; and
when the stress score is greater than the predefined threshold,
automatically transmit a notification to the console computer system for presentation to the CSR, via the communication device, wherein the notification includes a recommended mindfulness module for completion to reduce the stress score, and wherein the stress mitigation functions comprise at least automatically transmitting the notification.

15. A non-transitory, computer-readable medium containing instructions thereon, which, when executed by a processor, are capable of performing a method for providing monitoring and mitigating job-related stress for a customer service representative (CSR) using a console computer system in a customer service computer network, the method comprising:
establishing communication connections to at least the console computer system, the customer service computer network, and a remote server that stores a Customer Relationship Management (CRM) software platform that collects and stores stress metrics, by a communication device communicatively coupled to the processor;
obtaining a set of the stress metrics associated with the CSR, via the communication device, the set of the stress metrics comprising at least a quantity of cases assigned to the CSR, a second quantity of escalated cases assigned to the CSR, and a third quantity of case milestone violations associated with the CSR;
computing a stress score for the CSR, based on the set of the stress metrics from the CRM software platform, wherein the stress score indicates a level of job-related stress for the CSR;
transmitting the stress score for the CSR to the remote server for storage and use; and
when the stress score indicates a high level of job-related stress for the CSR, causing stress mitigation functions to be performed, the stress mitigation functions being associated with case assignments, case routing, and mindfulness module data, via the communication connections to the console computer system, the customer service computer network, and the remote server.

16. The non-transitory, computer-readable medium of claim 15, wherein the method further comprises:
transmitting mindfulness module data to the console computer system, via the customer service computer network;
receiving user input completion data to complete the mindfulness module data, via the communication connections, to generate a complete mindfulness module, wherein the set of the stress metrics comprises the complete mindfulness module.

17. The non-transitory, computer-readable medium of claim 15, wherein the method further comprises:
accessing a plurality of stress scores stored at the remote server via the CRM software platform, by the processor via the customer service computer network, wherein the stress metrics comprise at least the plurality of stress scores, and wherein the plurality of stress scores are associated with a plurality of CSRs;
generating one or more stress score reports for the plurality of CSRs, by the processor;
transmitting the one or more stress score reports to the remote server for storage and use; and
providing access to the one or more stress score reports, by the processor via the CRM software platform.

18. The non-transitory, computer-readable medium of claim 15, wherein the method further comprises:
accessing a plurality of stress scores stored at the remote server via the CRM software platform, by the processor, wherein the stress metrics comprise at least the plurality of stress scores, and wherein the plurality of stress scores are associated with a plurality of CSRs;
generating one or more stress score reports for the plurality of CSRs, by the processor; and
transmitting the one or more stress score reports, to a secondary computer system for user interpretation and use, via a communication device communicatively coupled to the processor.

19. The non-transitory, computer-readable medium of claim 15, wherein the method further comprises:
comparing the stress score for the CSR to a predefined threshold, by the processor; and
when the stress score is greater than the predefined threshold,
identifying a high priority case transmitted to the console computer system for handling by the CSR, by the processor; and
automatically re-routing the high priority case to a second CSR associated with a stress score less than the predefined threshold, by the processor and via the customer service computer network, wherein the stress mitigation functions comprise at least automatically re-routing the high priority case.

20. The non-transitory, computer-readable medium of claim 15, wherein the method further comprises:
comparing the stress score for the CSR to a predefined threshold, by the processor; and
when the stress score is greater than the predefined threshold,
automatically reducing a quantity of cases in a queue for the console computer system associated with the CSR, by re-routing a subset of the quantity to one or more CSRs associated with stress scores lower than the predefined threshold, by the processor and via the customer service computer network, wherein the stress mitigation functions comprise at least automatically reducing the quantity of cases in the queue.
